(19) United States
(12) Patent Application Publication
(10) Pub. No.: US 2026/0288272 A1
(43) Pub. Date: Sep. 24, 2026

(54) TOUCH-PANEL-INTEGRATED DISPLAY DEVICE

(71) Applicant: Sharp Display Technology Corporation, Kameyama City (JP)

(72) Inventors: Shinji YAMAGISHI, Kameyama City (JP); Kazutoshi KIDA, Kameyama City (JP); Takenori MARUYAMA, Kameyama City (JP); Yasuhiro SUGITA, Kameyama City (JP); Hiroshi FUKUSHIMA, Kameyama City (JP); Takuma YAMAMOTO, Kameyama City (JP)

(21) Appl. No.: 19/571,820

(22) Filed: Mar. 19, 2026

(30) Foreign Application Priority Data
Mar. 21, 2025 (JP) 2025-047510

(51) Int. Cl. G06F 3/041; G02F 1/1333; G02F 1/1362; G02F 1/1368; G06F 3/044

(52) U.S. Cl. CPC G06F 3/0412; G02F 1/13338; G02F 1/136286; G02F 1/1368; G06F 3/04164; G06F 3/0446

(57) ABSTRACT

A touch-panel-integrated display device includes: a common electrode layer; a wiring layer stacked and disposed on the common electrode layer via an insulation layer; and a touch panel driver, wherein each of the common electrode layer and the wiring layer contains a plurality of nodes that are arranged two-dimensionally, in each of the plurality of nodes, the common electrode layer contains: a drive electrode; a detection electrode; and a common electrode, and in each of the plurality of nodes, the wiring layer contains: a drive-electrode-connection wire overlapping the drive electrode in a plan view and connecting the drive electrode and the touch panel driver; a detection-electrode-connection wire overlapping the detection electrode in a plan view and connecting the detection electrode and the touch panel driver; and a dummy line overlapping the common electrode in a plan view.

### FIELD OF THE DISCLOSURE

The present disclosure relates to touch-panel-integrated display devices.

### BACKGROUND OF THE DISCLOSURE

A touch-panel-integrated display device disclosed in JP2022-114180A includes a plurality of drive electrodes, a plurality of detection electrodes, a plurality of pixel electrode groups, and a touch detection driver.

The touch detection driver, in a first period, does not supply a touch detection drive signal to a first drive electrode overlapping in a plan view a first pixel electrode group to which a gate signal is being supplied and supplies a touch detection drive signal to a second drive electrode overlapping in a plan view a second pixel electrode group to which no gate signal is being supplied. In addition, in the first period, the first drive electrode serves as a display electrode (opposite electrode disposed opposite a plurality of pixel electrodes (common electrode)).

### SUMMARY

To increase the physical size of the touch-panel-integrated display device described in JP2022-114180A, the size per one drive electrode and the size per one detection electrode increase. These increases in turn add to the load (capacitance and resistance) on the plurality of drive electrodes and the load on the plurality of detection electrodes. These additional loads could make it difficult to supply drive signals to the drive electrodes. In other words, to increase the physical size of the touch-panel-integrated display device, the waveform of the drive signal is progressively distorted due to the load for the drive electrodes that are positioned farther away from the driver, which could possibly preclude accurate touch detection.

The present disclosure has been made to address these problems and has an object to provide a touch-panel-integrated display device that can be increased in size by reducing loads on drive electrodes and detection electrodes.

To address the problems, the present disclosure, in an aspect thereof, is directed to a touch-panel-integrated display device including: a plurality of pixel electrodes; a common electrode layer disposed opposite the plurality of pixel electrodes; a wiring layer stacked and disposed on the common electrode layer via an insulation layer; and a touch panel driver, wherein each of the common electrode layer and the wiring layer contains a plurality of nodes that are arranged two-dimensionally, in each of the plurality of nodes, the common electrode layer contains: at least one drive electrode; at least one detection electrode forming an electrostatic capacitance between the at least one detection electrode and the at least one drive electrode; and a common electrode located between the at least one drive electrode and the at least one detection electrode and an adjacent one of the plurality of nodes, and in each of the plurality of nodes, the wiring layer contains: a drive-electrode-connection wire overlapping the at least one drive electrode in a plan view and connecting the at least one drive electrode and the touch panel driver; a detection-electrode-connection wire overlapping the at least one detection electrode in a plan view and connecting the at least one detection electrode and the touch panel driver; and a dummy line overlapping the common electrode in a plan view.

The foregoing configuration allows for increases in size of the touch-panel-integrated display device by reducing loads on the drive electrodes and the detection electrodes. In addition, the configuration allows for high-quality image displays.

### BRIEF DESCRIPTION OF DRAWINGS

FIG. 1 is a block diagram of a functional configuration of a display device in accordance with Embodiment 1.

FIG. 2 is a schematic cross-sectional view of an exemplary structure of the display device.

FIG. 3 is a schematic diagram of a circuit structure of a TFT substrate.

FIG. 4 is a circuit diagram of an exemplary structure of a pixel.

FIG. 5 is a plan view of an arrangement of electrodes formed in a common electrode layer.

FIG. 6 is an enlarged plan view of a single node in a touch panel.

FIG. 7 is a plan view of an arrangement of major structural elements of a color pixel in a TFT substrate.

FIG. 8 is a plan view of an arrangement of major structural elements of a color pixel in a TFT substrate.

FIG. 9 is a cross-sectional view of the TFT substrate taken along line A-A shown in FIG. 7.

FIG. 10 is a cross-sectional view of the TFT substrate taken along line B-B shown in FIG. 7.

FIG. 11 is a plan view of the shapes of detection electrodes and drive electrodes near a boundary.

FIG. 12 is a plan view of an arrangement of wires in a node.

FIG. 13 is a plan view of a structure of a wiring layer 13 and a common electrode layer 12 in a pixel where there is provided a drive-electrode-connection wire 13A.

FIG. 14 is a plan view of a structure of a dummy line 13C and a common electrode 12C in a pixel where the dummy line 13C is provided.

FIG. 15 is a plan view of the connection of a lead wire and a drive-electrode-connection wire in a region R1 shown in FIG. 12.

FIG. 16 is a plan view of an exemplary structure of a lead wire and a drive-electrode-connection wire in a region R2 shown in FIG. 12.

FIG. 17 is a plan view of an exemplary structure of a detection-electrode-lead wire and a drive-electrode-connection wire in a region R3 shown in FIG. 12.

FIG. 18 represents an example of a displayed image when a touch-panel-integrated display device in accordance with Embodiment 1 is controlled to display a grayscale color across the screen.

FIG. 19 represents an example of a displayed image when a touch-panel-integrated display device 101 in accordance with a comparative example with no dummy line 13C is controlled to display a grayscale color across the screen.

FIG. 20 is a plan view of an exemplary structure of a dummy line and a common electrode 12C in a touch-panel-integrated display device in accordance with Embodiment 2.

### DESCRIPTION OF EMBODIMENTS

The following will describe embodiments of the present disclosure in detail with reference to drawings. Identical and equivalent members will be denoted by the same reference signs throughout the drawings, and description thereof is not repeated. For clarity purposes, the drawings to which reference will be made in the following description may show structures in a simplified or schematic form or may omit some structural members. The relative dimensions of structural members as they are shown in the drawings may not represent the actual relative dimensions thereof. In addition, throughout the specification of the present application, a conductor means an electrical conductor that exhibits a low resistance, and a connection means an electrical connection with a low resistance unless otherwise mentioned.

### Embodiment 1

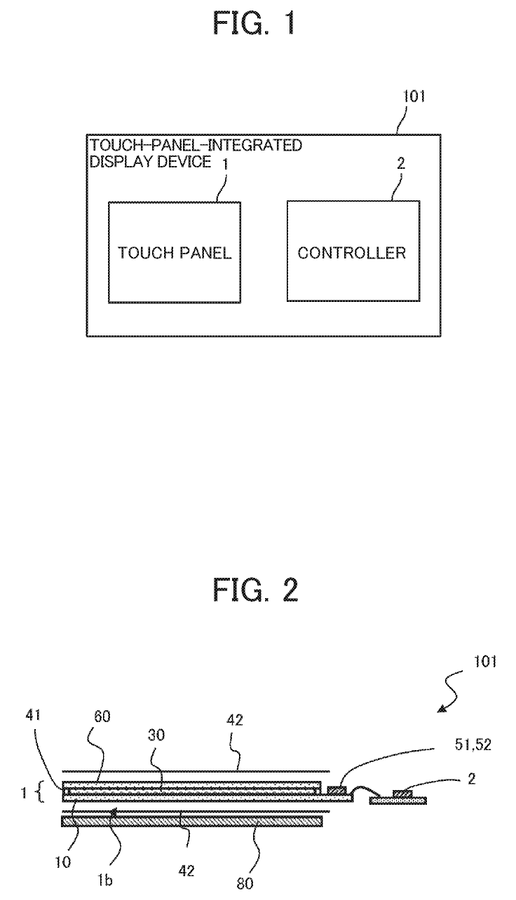

A description is given now of a structure of a touch-panel-integrated display device 101 in accordance with Embodiment 1. FIG. 1 is a block diagram of a functional configuration of the touch-panel-integrated display device 101 in accordance with Embodiment 1.

Referring to FIG. 1, the touch-panel-integrated display device 101 includes a touch panel 1 and a controller 2. The touch panel 1 is, for example, a full in-cell touch panel. The touch panel 1 functions as a display panel for displaying videos or images. The controller 2 performs control processes in the touch-panel-integrated display device 101 on the basis of the touch detection information acquired from the touch panel 1 (e.g., touch positions).

FIG. 2 is a schematic cross-sectional view of an exemplary structure of the touch-panel-integrated display device 101. The touch panel 1 includes a TFT substrate (active matrix substrate) 10, an opposite substrate 60, and a liquid crystal layer 30. The liquid crystal layer 30 is provided between the TFT substrate 10 and the opposite substrate 60 and sealed with a sealant 41 between the TFT substrate 10 and the opposite substrate 60.

The TFT substrate 10 includes a plurality of pixels arranged two-dimensionally in a display area as will be described later in detail. The opposite substrate 60 includes color filters (not shown) disposed in locations corresponding to the pixels.

The touch-panel-integrated display device 101 may further include a pair of polarizers 42 and a backlight 80. The pair of polarizers 42 is disposed in a crossed Nicol position sandwiching the touch panel 1. The backlight 80 is disposed on a rear face 1b of the touch panel 1. The backlight 80 may be either an edge-lit backlight or a direct backlight. In addition, the backlight 80 may be capable of being partially driven.

Each polarizer 42 has, for example, protection glass (not shown) on its surface. The outermost layer of this protection glass and other members provides a touch surface (surface to be touched by an indicator). For example, the user can visually recognize images on the front surface of the polarizer 42. In addition, the touch panel 1 accepts a manual touch operation by, for example, a finger (indicator) on the touch surface.

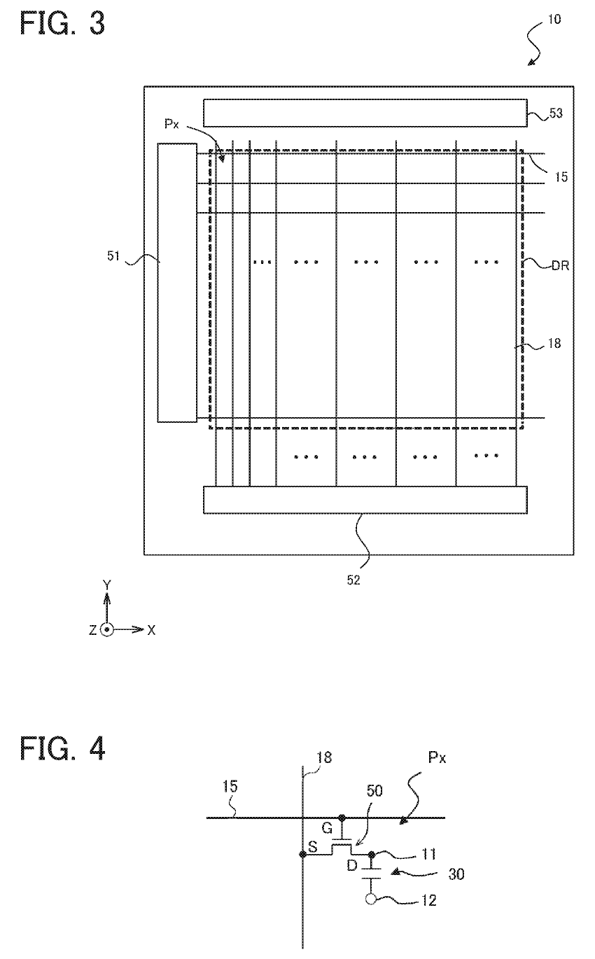

FIG. 3 is a schematic diagram of a circuit structure of the TFT substrate 10, and FIG. 4 is a circuit diagram of an exemplary structure of one of the pixels. The TFT substrate 10 includes: a plurality of gate lines 15 extending in the row direction (x-axis direction) and arranged side by side in the column direction (y-axis direction); a plurality of source lines 18 extending in the column direction and arranged side by side in the row direction; a plurality of pixels Px; a gate driver 51; a source driver 52; and a touch panel driver 53. The plurality of gate lines 15 and the plurality of source lines 18 are provided in a display area DR and connected respectively to the gate driver 51 and the source driver 52 both disposed outside the display area DR. The touch panel driver 53 (detailed later) is also disposed outside the display area DR.

Each pixel Px is disposed in a region surrounded by a pair of adjacent gate lines 15 and a pair of adjacent source lines 18. Referring to FIG. 4, each pixel Px includes a thin film transistor 50, a pixel electrode 11, and a common electrode layer 12. The thin film transistor 50 has a gate G thereof connected to one of the gate lines 15 and a source S thereof connected to one of the source lines 18. The thin film transistor 50 has a drain D thereof connected to the pixel electrode 11. As will be described later in detail, the common electrode layer 12 is disposed opposite the pixel electrode 11, and the electric field generated by the voltage applied across the pixel electrode 11 and the common electrode layer 12 is applied to the liquid crystal layer 30 so as to control the orientation of the liquid crystal in the liquid crystal layer 30.

The common electrode layer 12 is alternatively referred to as the opposite electrode, contains a transparent conductor, and when a voltage is applied to the liquid crystal layer 30, is fed with a reference voltage. In typical liquid crystal display devices, the common electrode layer contains a continuous conductor spreading across the entire display area. In contrast, in full in-cell touch panels, the common electrode layer is divided to construct electrodes for detecting a touch position.

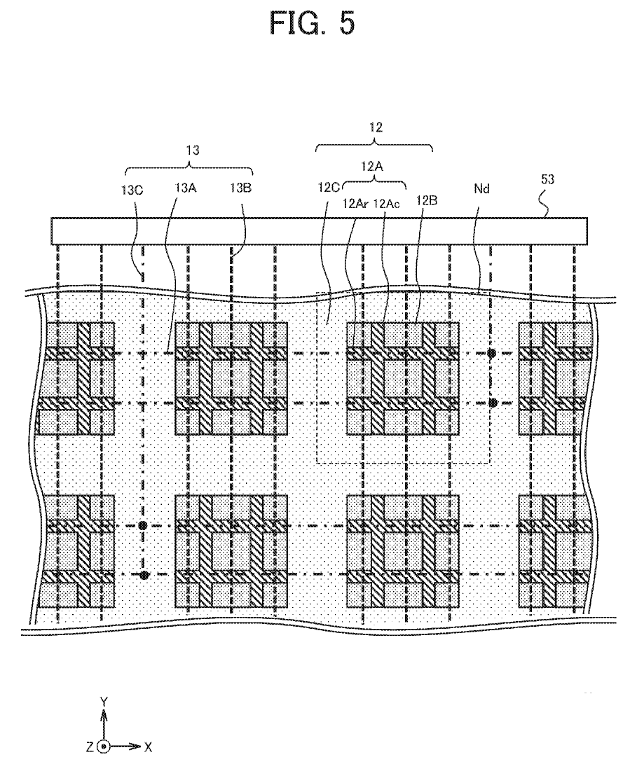

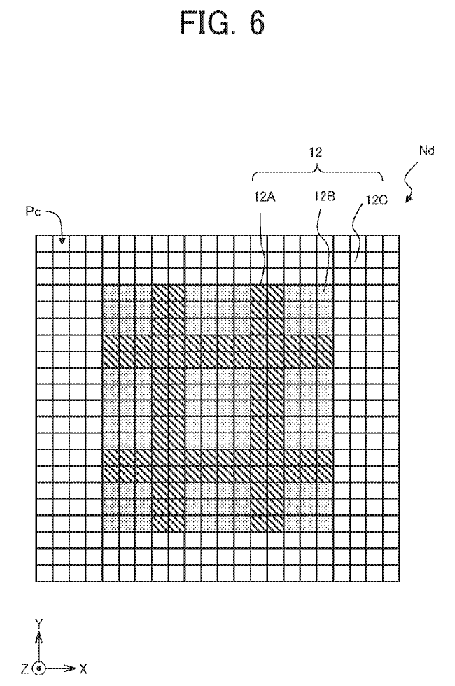

FIG. 5 is a plan view of an arrangement of electrodes formed in the common electrode layer 12, and FIG. 6 is an enlarged plan view of a single node in a touch panel. In FIG. 6, each small square represents a group of three red, green, and blue pixels that as a whole give off white color. These three pixels will be referred to as color pixels Pc in the following description. In some cases, the color pixels Pc may be simply referred to as the “pixels,” and the red, green, and blue pixels may be referred to as the subpixels.

Referring to FIG. 5, the touch panel 1 includes a plurality of nodes Nd providing an input unit coordinate. The nodes Nd are arranged two-dimensionally in the row and column directions. In each node Nd, the common electrode layer 12 includes: at least one drive electrode 12A; at least one detection electrode 12B; and a common electrode 12C positioned between these drive and detection electrodes 12A and 12B and those drive and detection electrodes 12A and 12B in the adjacent one of the nodes Nd. In addition, the touch panel 1includes: a wiring layer 13 for transferring a drive signal and a detection signal; and the touch panel driver 53 that outputs a drive signal and determines a touch position from a detection signal.

In the present embodiment, each node Nd includes a single drive electrode 12A and a plurality of detection electrodes 12B. The plurality of detection electrodes 12B are arranged two-dimensionally in the row and column directions. More specifically, the touch panel 1 includes the detection electrodes 12B arranged in m rows and n columns (m and n are natural numbers) in each node Nd. For example, each node Nd includes nine detection electrodes 12B arranged in three rows and three columns. The detection electrodes 12B may be all identical or differ from each other in size and shape.

The drive electrode 12A is located between the nine detection electrodes 12B and shaped like a grid. The detection electrodes 12B and the drive electrode 12A are adjacent to each other. More particularly, the drive electrode 12A is disposed so that two conductors 12Ar extending in the row direction and arranged in the column direction and two conductors 12Ac extending in the column direction and arranged in the row direction cross each other, forming a grid-like shape when viewed as a whole.

In each node Nd, the common electrode 12C surrounds the plurality of detection electrodes 12B and the drive electrode 12A seamlessly. The common electrode 12C is continuous with the common electrode 12C for the adjacent node Nd to form an integrated conductor.

The wiring layer 13 is a member provided additionally in a common liquid crystal panel to construct a full in-cell touch panel. The wiring layer 13 is made of a metal and includes a drive-electrode-connection wire 13A, a detection-electrode-connection wire 13B, a dummy line 13C, a lead wire 13D, and a conductive wire 13E, as will be described later in detail. As indicated schematically by broken lines in FIG. 5, the drive-electrode-connection wire 13A overlaps the drive electrode 12A in a plan view to connect the drive electrode 12A and the touch panel driver 53. More specifically, the drive-electrode-connection wire 13A extends in the row direction and is connected to the drive electrode 12A in the region where the drive-electrode-connection wire 13A overlaps the drive electrode 12A. Each drive-electrode-connection wire 13A is connected to the lead wire 13D extending in the column direction, and the lead wire 13D is connected to the touch panel driver 53.

Meanwhile, the detection-electrode-connection wire 13B overlaps the detection electrode 12B in a plan view to connect the detection electrodes 12B and the touch panel driver 53. More specifically, the detection-electrode-connection wire 13B extends in the column direction and is connected to the detection electrode 12B in the region where the detection-electrode-connection wire 13B overlaps the detection electrode 12B. In addition, each detection-electrode-connection wire 13B has an end thereof connected to the touch panel driver 53.

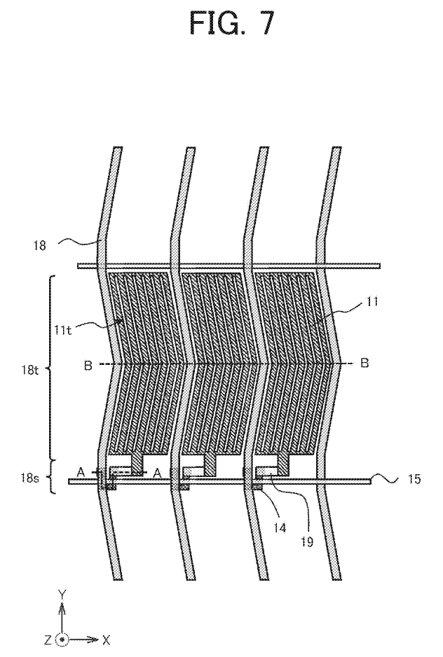

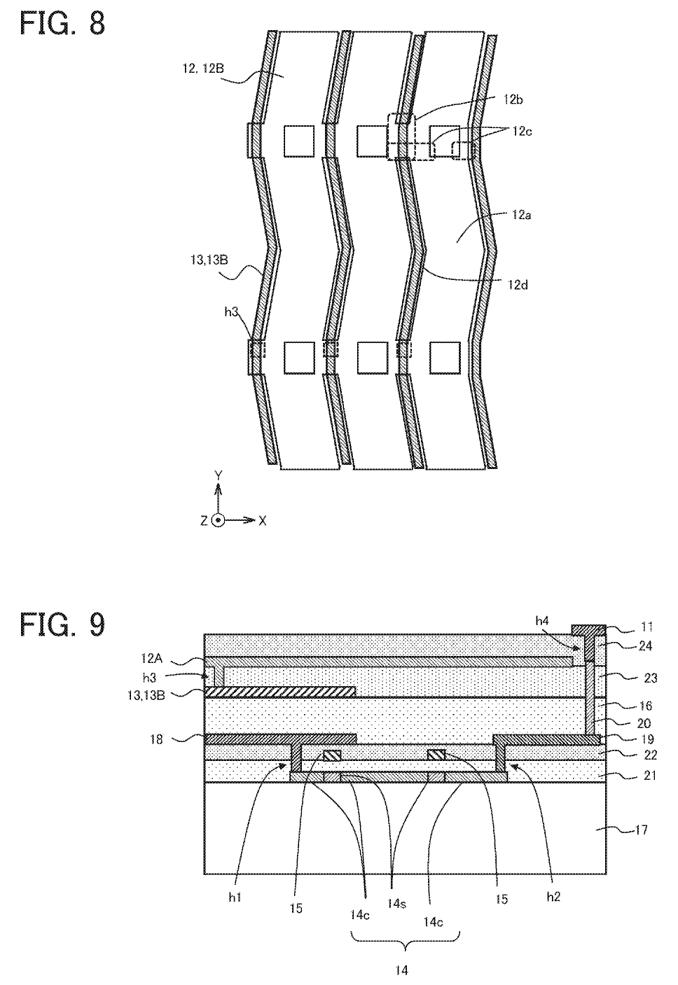

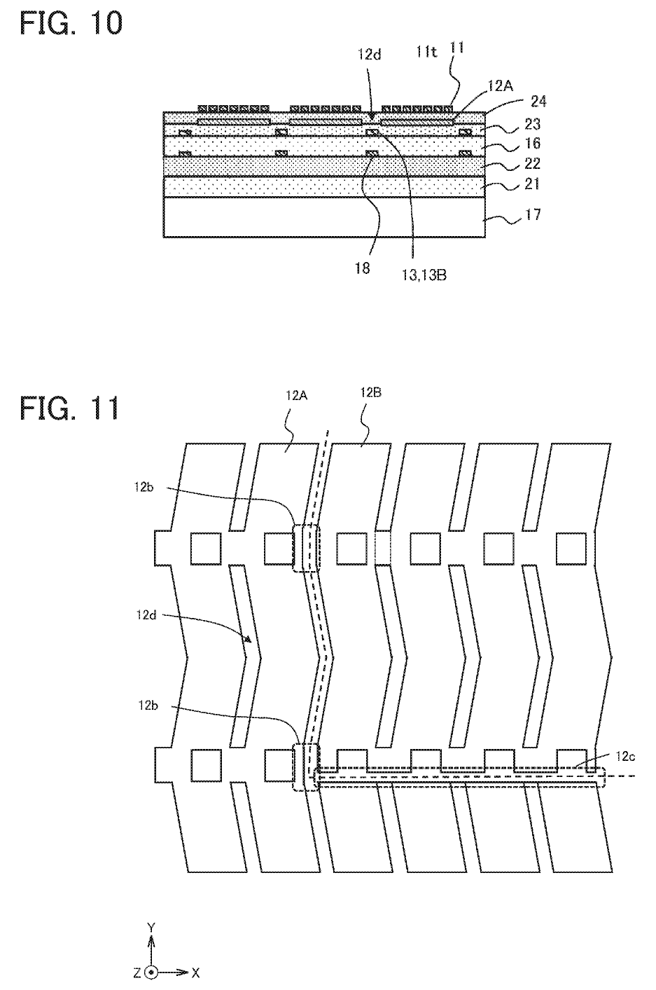

A description is given next of a specific exemplary structure of the node Nd. FIGS. 7 and 8 are plan views of an arrangement of major structural elements of the color pixel Pc in the TFT substrate 10. FIGS. 9 and 10 are cross-sectional views of the TFT substrate 10 taken along line A-A and line B-B shown in FIG. 7.

The TFT substrate 10 includes the gate lines 15, the source lines 18, the pixel electrodes 11, the common electrode layer 12, and the wiring layer 13, all described above, and further includes a transparent substrate 17, a semiconductor layer 14, a first insulation layer 21, a second insulation layer 22, and a first conductive layer 19, a second conductive layer 20, a transparent resin layer 16, a third insulation layer 23, and a fourth insulation layer 24.

Of these members, FIG. 7 shows the gate lines 15, the source lines 18, the pixel electrodes 11, the semiconductor layer 14, and the first conductive layer 19. The structures of these members, including their shapes, are the same in any of the color pixels Pc and a pixel Pix in the display area DR. In addition, FIG. 8 shows the wiring layer 13 and the common electrode layer 12. The structures of these members, including their shapes, differ depending on whether the common electrode layer 12 is the drive electrode 12A, the detection electrode 12B, or the common electrode 12C and also on in which of these electrodes the pixel is located. FIG. 8 shows the structure of the color pixel Pc in a region of the detection electrode 12B where the detection-electrode-connection wire 13B is provided.

The semiconductor layer 14 is supported by the transparent substrate 17. In the present embodiment, the semiconductor layer 14 is shaped like a letter U. The first insulation layer 21 is located on the transparent substrate 17, covering the semiconductor layer 14.

The gate line 15 extends parallel to the row direction and is arranged on the first insulation layer 21 so as to overlap the semiconductor layer 14 in a plan view. Specifically, the gate line 15 is arranged so as to overlap, at two locations, the U-shaped portion of the semiconductor layer 14 that extends in the column direction. The semiconductor layer 14 includes, in a plan view, a semiconductor region 14s overlapping the gate line 15 and a conductive region 14c not overlapping the gate line 15.

In the present embodiment, the semiconductor layer 14 is shaped like a letter U, and for this reason, the thin film transistor 50 has a dual gate structure. However, the thin film transistor 50 may have a common single gate structure.

The second insulation layer 22 is disposed on the first insulation layer 21, covering the gate line 15. The second insulation layer 22 and the first insulation layer 21 have a contact hole h1 and a contact hole h2 for exposing parts of the semiconductor layer 14.

The source line 18 is provided in the contact hole h1 and on the second insulation layer 22 and connected to the semiconductor layer 14 via the contact hole h1. In addition, the first conductive layer 19 is provided in the contact hole h2 and on the second insulation layer 22 and connected to the semiconductor layer 14 via the contact hole h2. The first insulation layer 21 and the second insulation layer 22 are made of, for example, an inorganic material such as silicon oxide or silicon nitride.

Referring to FIG. 7, the source line 18 includes straight line portions 18s extending parallel to the column direction and bending portions 18t bent like a letter V in the row direction. Those straight-line portions 18s that are located at both ends of the bending portion 18t are positioned on the same straight line extending in the column direction, and therefore the source line 18, as a whole, extends parallel to the column direction.

The transparent resin layer 16 is disposed on the second insulation layer 22, covering the source line 18 and the first conductive layer 19. The transparent resin layer 16 is a planarization layer for planarizing the top face of the second insulation layer 22.

The wiring layer 13 (detection-electrode-connection wire 13B) is disposed on the transparent resin layer 16. The wiring layer 13 will be described later in detail.

The third insulation layer 23 is disposed on the transparent resin layer 16, covering the wiring layer 13. The third insulation layer 23 has a contact hole h3 for exposing a part of the wiring layer 13.

The common electrode layer 12 is provided in the contact hole h3 and on the third insulation layer 23 and connected to the wiring layer 13 via the contact hole h3.

The fourth insulation layer 24 is disposed on the third insulation layer 23, covering the common electrode layer 12. The fourth insulation layer 24, the third insulation layer 23, and the transparent resin layer 16 have a contact hole h4 for exposing a part of the first conductive layer 19. The contact hole h4 is partially filled with the second conductive layer 20, and the second conductive layer 20 is connected to the first conductive layer 19.

The pixel electrode 11 is provided in a part of the contact hole h4 and on the fourth insulation layer 24 and connected to the first conductive layer 19 and the second conductive layer 20 via the contact hole h4. Hence, the pixel electrode 11 is connected to the semiconductor layer 14 via the first conductive layer 19 and the second conductive layer 20. The pixel electrode 11 has a plurality of slits 11t extending along the bending portion 18t of the source line 18.

A detailed description is given next of the structure of the common electrode layer 12 and the wiring layer 13. Referring to FIGS. 8 and 10, the common electrode layer 12 includes a first connecting portion 12b and a second connecting portion 12c both for connecting a main portion 12a located in each pixel Pix to the main portion 12a in an adjacent pixel. The main portion 12a is disposed opposite the pixel electrode 11 via the fourth insulation layer. The first connecting portion 12b connects a pair of main portions 12a in the pixels Pix that are adjacent to each other in the row direction, and the second connecting portion 12c connects a pair of main portions 12a in the pixels Pix that are adjacent to each other in the column direction.

In each of the drive electrode 12A, the detection electrode 12B, and the common electrode 12C, the main portions 12a in the pixels Pix in the common electrode layer 12 are connected to each other by the first connecting portion 12b and the second connecting portion 12c, to form an integrated transparent electrode.

In contrast, between any two of the drive electrode 12A, the detection electrode 12B, and the common electrode 12C, since the first connecting portion 12b and/or the second connecting portion 12c is/are not provided, the main portions 12a are not connected to each other, that is, the main portions 12a are electrically insulated from each other. For example, FIG. 11 shows the shapes of the detection electrode 12B and the drive electrode 12A in a location where the drive electrode 12A is located adjacent to one of four corners of the detection electrode 12B. As indicated by broken lines in FIG. 11, along the boundary between the detection electrode 12B and the drive electrode 12A, since the first connecting portion 12b and the second connecting portion 12c are removed, the detection electrode 12B and the drive electrode 12A are electrically insulated.

In addition, in each of the drive electrode 12A, the detection electrode 12B, and the common electrode 12C, there is provided a slit 12d between each pair of main portions 12a that are adjacent to each other in the row direction. Since the main portions 12a overlap the pixel electrodes 11 in a plan view, the slit 12d is located between a pair of pixel electrodes 11 that are adjacent to each other in a plan view. In addition, referring to FIG. 10, the slit 12d overlaps the source line 18 in a plan view.

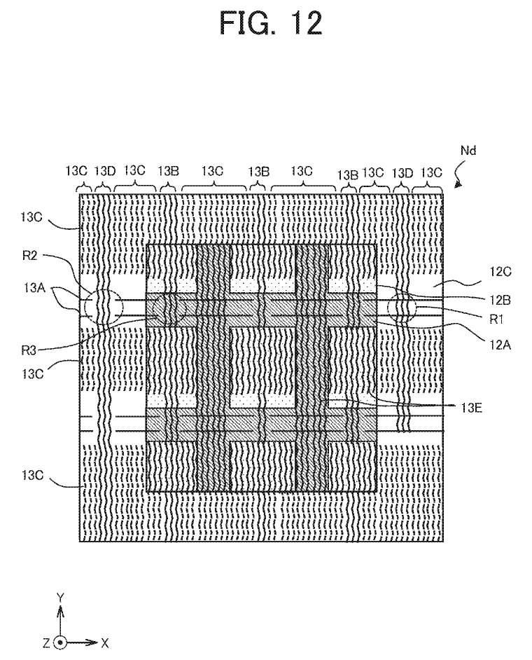

As described above, the wiring layer 13 includes the drive-electrode-connection wire 13A, the detection-electrode-connection wire 13B, the dummy line 13C, the lead wire 13D, and the conductive wire 13E. FIG. 12 is a plan view of an arrangement of these lines and wires in the node Nd. Of these lines and wires, the detection-electrode-connection wire 13B, the dummy line 13C, and the lead wire 13D extend in the column direction, and the drive-electrode-connection wire 13A extends in the row direction. The dummy line 13C is represented by a broken line for ease in understanding.

The detection-electrode-connection wire 13B overlaps the source line 18 in a plan view (FIG. 10) and extends in the column direction. In addition, the detection-electrode-connection wire 13B overlaps the slit 12d in a plan view.

Referring to FIG. 8, in each detection electrode 12B, the detection-electrode-connection wire 13B is connected to the detection electrode 12B via the contact hole h3 provided in the third insulation layer 23.

The detection-electrode-connection wire 13B, in each detection electrode 12B, is connected to the detection-electrode-connection wire 13B in the pixel that is adjacent in the column direction. Furthermore, the detection-electrode-connection wire 13B is provided and connected in the pixel for the common electrode 12C and the pixel for the drive electrode 12A that are adjacent to the detection electrode 12B in the column direction. It should be noted however that since the pixel for the common electrode 12C and the drive electrode 12A have no contact hole h3, the common electrode 12C and the drive electrode 12A are not connected to the detection-electrode-connection wire 13B. Therefore, the detection-electrode-connection wire 13B is electrically insulated from the common electrode 12C and the drive electrode 12A.

In the above-described configuration, the plurality of detection electrodes 12B arranged in the column direction are connected to each other by the detection-electrode-connection wire 13B in each node Nd. FIG. 12 shows that the plurality of detection electrodes 12B arranged in the column direction are connected by two or three detection-electrode-connection wires 13B. The number of the detection-electrode-connection wires 13B may be one and may be four or even greater.

In addition, in each node Nd, the detection-electrode-connection wire 13B is drawn out in the column direction and located also over the common electrode 12C. Referring to FIG. 5, the nodes Nd are arranged two-dimensionally in the row and column directions, and the detection-electrode-connection wires 13B in those nodes Nd that are adjacent to each other in the column direction are connected to each other.

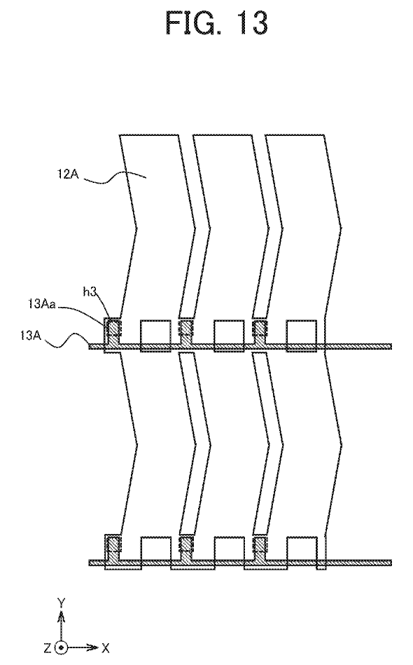

FIG. 13 is a plan view of a structure of the drive-electrode-connection wire 13A and the drive electrode 12A in a pixel where the drive-electrode-connection wire 13A is located. The drive-electrode-connection wire 13A extends in the row direction and, for example, overlaps the gate line 15 in a plan view. In the drive electrode 12A, the drive-electrode-connection wire 13A includes a connecting portion 13Aa protruding in the column direction, and the connecting portion 13Aa is connected to the drive electrode 12A via the contact hole h3 provided in the third insulation layer 23.

In the drive electrode 12A, the drive-electrode-connection wire 13A is connected to the drive-electrode-connection wire 13A for the pixel that is adjacent in the row direction. Furthermore, the drive-electrode-connection wire 13A is provided and connected in the pixel for the common electrode 12C that is adjacent to the drive electrode 12A in the row direction. It should be noted however that since the pixel for the common electrode 12C has no contact hole h3, the common electrode 12C and the drive-electrode-connection wire 13A are not connected. Therefore, the drive-electrode-connection wire 13A is electrically insulated from the common electrode 12C.

In the above-described configuration, in one node Nd, two of the drive-electrode-connection wires 13A are provided for each of two row-direction-extending conductors 12r of the grid-like drive electrodes 12A, but alternatively, the number of the drive-electrode-connection wires 13A may be two or greater for each conductor 12r.

In addition, in each node Nd, the drive-electrode-connection wire 13A is drawn out in the row direction also to the common electrode 12C. Referring to FIG. 5, the nodes Nd are arranged two-dimensionally in the row and column directions, and the drive-electrode-connection wires 13A in those nodes Nd that are adjacent to each other in the row direction are connected to each other.

Referring to FIG. 12, the wiring layer 13 may further include the conductive wire 13E to reduce the electrical resistances of the drive electrode 12A and the detection electrode 12B. The conductive wire 13E is a conductor that has the same structure as the detection-electrode-connection wire 13B shown in FIG. 8, and in the drive electrode 12A and the detection electrode 12B, the conductive wire 13E is connected to the conductive wire 13E for the pixel that is adjacent in the column direction. In addition, the conductive wire 13E and the drive electrode 12A are connected via two or more contact holes h3. Similarly, the conductive wire 13E and the detection electrode 12B are connected via two or more contact holes h3. Since the drive electrode 12A and the detection electrode 12B are each connected to the metallic conductive wire 13E at two or more locations, the electrical resistances of the drive electrode 12A and the detection electrode 12B can be reduced.

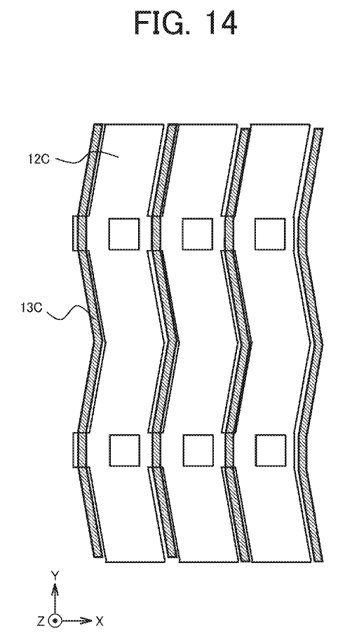

FIG. 14 is a plan view of a structure of the dummy line 13C and the common electrode 12C in a pixel where the dummy line 13C is provided. The dummy line 13C is a conductor that has the same structure as the detection-electrode-connection wire 13B shown in FIG. 8. It should be noted however that in the present embodiment, the dummy line 13C is not connected to the common electrode 12C. In other words, in the pixel where the common electrode 12C is provided, the third insulation layer 23 has no contact hole h3. In the example shown in FIG. 14, in the common electrode 12C, the dummy line 13C is connected to the dummy line 13C for the pixel that is adjacent in the column direction. However, the dummy line 13C may not be connected between a pair of pixels that are adjacent to each other in the column direction.

The dummy line 13C, in the present embodiment, is not connected to any electrical potential, hence being floated. The common electrode 12C is connected to the reference potential.

The lead wire 13D is a conductor that has the same structure as the detection-electrode-connection wire 13B shown in FIG. 8. It should be noted however that the lead wire 13D is not connected to the common electrode 12C. The lead wire 13D is a column-direction extension of the drive-electrode-connection wire 13A extending in the row direction and connects the touch panel driver 53 to the drive-electrode-connection wire 13A.

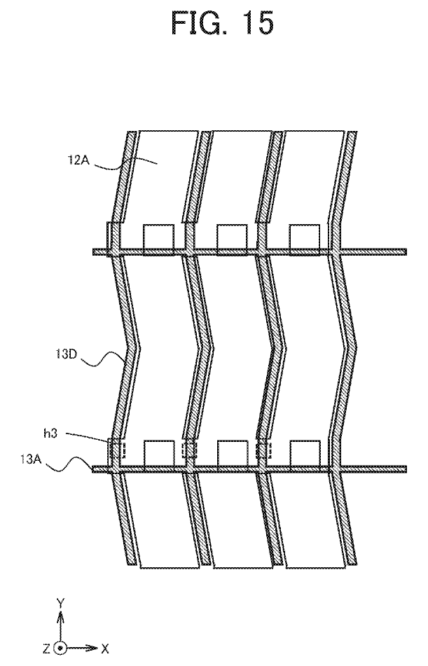

The touch panel driver 53 detects a touch on the plurality of nodes Nd arranged in the row and column directions by outputting a drive signal to the plurality of nodes Nd on a row-by-row basis and receiving a detection signal from the nodes Nd on a column-by-column basis. Therefore, the lead wire 13D is connected to the drive-electrode-connection wire 13A for each row of nodes Nd. For example, the lead wire 13D located to the right of the node Nd shown in FIG. 12 is connected to the drive-electrode-connection wire 13A provided in the node Nd. FIG. 15 is a plan view of the connection of the lead wire 13D and the drive-electrode-connection wire 13A in a region R1 (FIG. 12). Since the lead wire 13D and the drive-electrode-connection wire 13A are located in the same layer, the lead wire 13D and the drive-electrode-connection wire 13A can be connected by patterning a metal layer from which the wiring layer 13 is obtained so that the lead wire 13D intersects the drive-electrode-connection wire 13A.

In contrast, the lead wire 13D located to the left of the node Nd shown in FIG. 12 is connected to, for example, the drive-electrode-connection wire 13A in the node Nd located below the node Nd shown in FIG. 12 in the column direction. This lead wire 13D is not connected to the drive-electrode-connection wire 13A in the node Nd shown in FIG. 12. Therefore, the drive-electrode-connection wire 13A is divided in the region that intersects the lead wire 13D so that the lead wire 13D and the drive-electrode-connection wire 13A do not intersect in a region R2 shown in FIG. 12.

It should be noted however that the drive-electrode-connection wires 13A need to be electrically connected between those nodes Nd that are adjacent to each other in the row direction. Therefore, a part of the common electrode 12C is separated to use the separated part of the common electrode 12C as a conductor, thereby connecting the divided drive-electrode-connection wires 13A.

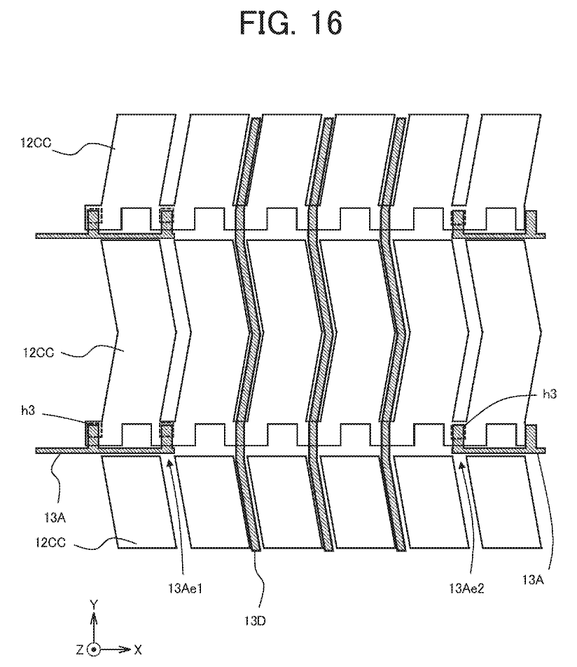

FIG. 16 is a plan view of an exemplary structure of the lead wire 13D and the drive-electrode-connection wire 13A in the region R2. Referring to FIG. 16, a connection conductor 12CC is separated from the common electrode 12C by removing the second connecting portion 12c of the common electrode 12C in a location where the drive-electrode-connection wire 13A is extended. In addition, the divided drive-electrode-connection wires 13A are connected at ends 13Ae1, 13Ae2 thereof to the connection conductor 12CC via the contact hole h3 (FIG. 8). In this structure, even when the lead wire 13D and the drive-electrode-connection wire 13A are provided in the same layer, the detection signal and the drive signal can be transferred in two intersecting directions.

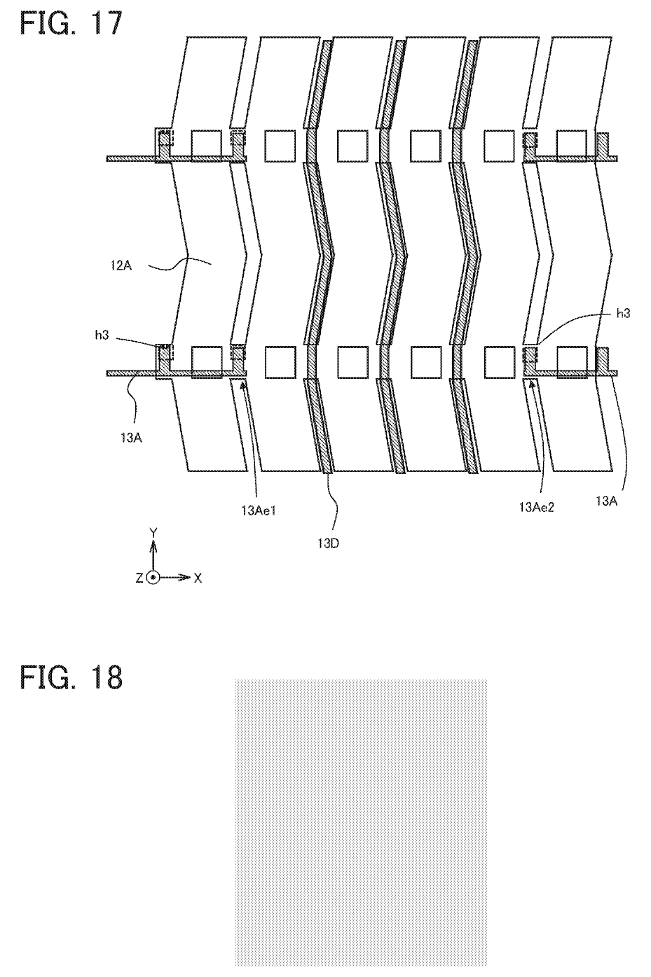

The detection-electrode-connection wire 13B also extends in the column direction. Therefore, the same structure is employed in a region R3 where the drive-electrode-connection wire 13A intersects the detection-electrode-connection wire 13B. FIG. 17 is a plan view of an exemplary structure of the detection-electrode-connection wire 13B and the drive-electrode-connection wire 13A in the region R3. The region R3 structurally differs from the region R2 shown in FIG. 17 in that in the former, the drive-electrode-connection wire 13A is provided in a position overlapping the drive electrode 12A. Since the drive-electrode-connection wire 13A and the drive electrode 12A are connected as described earlier, it is not necessary to construct a connection conductor by separating a part of the drive electrode 12A, to connect the divided drive-electrode-connection wires 13A in the region R3. The divided drive-electrode-connection wires 13A are connected at the ends 13Ae1, 13Ae2 thereof to the drive electrode 12A via the contact hole h3. In this structure, even when the drive-electrode-connection wire 13A and the detection-electrode-connection wire 13B are provided in the same layer, the detection signal and the drive signal can be transferred in two intersecting directions.

The touch-panel-integrated display device 101 can be manufactured by combining semiconductor manufacturing steps used commonly in the manufacture of touch-panel-integrated display devices. The drive electrodes 12A, the detection electrodes 12B, and the common electrode 12C in the common electrode layer 12 can be simultaneously formed by, for example, forming a transparent conductive layer of a transparent conductive material such as ITO and then patterning the transparent conductive layer. The drive-electrode-connection wires 13A, the detection-electrode-connection wires 13B, the lead wires 13D, and the conductive wires 13E in the wiring layer 13 can be simultaneously formed by, for example, forming a metal layer that is either a monolayer of a metal such as tungsten, tantalum, titanium, aluminum, nickel, gold, silver, or copper or of an alloy of any of these metals or a stack of two or more layers of any of these metals and alloys and then patterning the metal/alloy layer.

At a timing at which there is no gate signal being applied to the gate line for any of the pixels in one of the rows for the plurality of nodes Nd, the touch-panel-integrated display device 101 applies a drive signal to the drive-electrode-connection wire 13A for that one of the rows and receives a detection signal from the detection-electrode-connection wire 13B. By sequentially applying a drive signal with respect to the other rows for the plurality of nodes Nd in a similar manner, a touch by a finger or other indicator is detected across the entire display area DR. More specifically, for example, images can be displayed on the touch panel 1 and in addition, the position of a touch made by for example, a finger can be detected, in accordance with the control method for a touch-panel-integrated display device disclosed in JP2022-114180A.

In the touch-panel-integrated display device 101 in accordance with the present embodiment, since the common electrode is provided in each node, the drive electrode and the detection electrode can be relatively reduced in area. Therefore, the load (capacitance and resistance) on the drive electrode and the detection electrode can be reduced, and even when the touch-panel-integrated display device is increased in size, the waveform of a drive signal can be restrained from being deformed, which enables accurate detection of touch positions.

The common electrode is connected to the reference potential and positioned between the drive electrode and the detection electrode of each node and the adjacent nodes. Meanwhile, the drive electrode and the detection electrode are disposed adjacent to each other. Therefore, the adverse effects, such as decreases in detection sensitivity, caused by the provision of the common electrode can be restrained.

In addition, the provision of the dummy lines for the common electrode can reduce the structural difference of the drive electrode and the detection electrode from the common electrode, and therefore, non-uniform displays caused by the structural difference can be restrained.

FIG. 18 represents an example of an image when the touch-panel-integrated display device 101 in accordance with the present embodiment is controlled to display a grayscale color (gray) across the screen. FIG. 18 shows that the entire image consists of a generally uniform intermediate color, which demonstrates that the luminance non-uniformity is restrained.

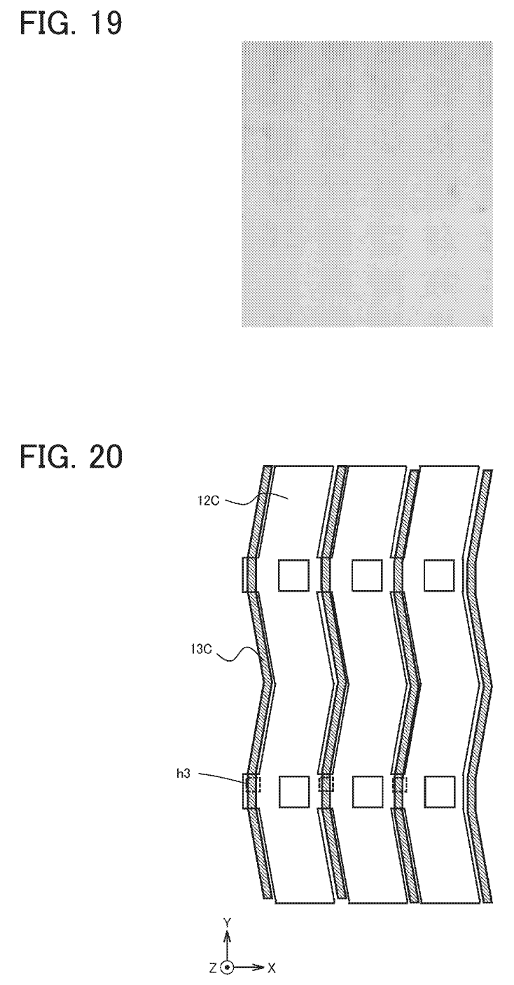

FIG. 19 represents an example of an image for comparison when a touch-panel-integrated display device 101 in accordance with a comparative example fabricated with no dummy lines 13C being provided for the common electrode 12C is controlled to display a grayscale color (gray) across the entire screen. FIG. 19 shows that luminance differences have developed in the image between the regions where the detection electrodes 12B and the drive electrodes 12A are provided and the region where the common electrode 12C is provided surrounding these electrodes, producing easily recognizable grid-like luminance non-uniformity.

In this manner, the touch-panel-integrated display device 101 in accordance with the present embodiment can effectively restrain luminance non-uniformity on the screen when the touch-panel-integrated display device 101 is controlled to display an intermediate grayscale color.

### Embodiment 2

FIG. 20 is a plan view of a structure of the dummy line 13C and the common electrode 12C for the pixel where the dummy line 13C is provided. A touch-panel-integrated display device in accordance with the present embodiment differs from Embodiment 1 in that in the former, the dummy line 13C is connected to the common electrode 12C. Specifically, there is provided a contact hole h3 in the third insulation layer 23, and the dummy line 13C and the common electrode 12C are connected together via the contact hole h3. In this structure, the dummy line 13C is connected to the reference potential as is the common electrode 12C.

As described in Embodiment 1, the dummy line 13C is a conductor that has the same structure as the detection-electrode-connection wire 13B, overlaps the source line 18 in a plan view, and extends in the column direction. In addition, the dummy line 13C overlaps the slit 12d in a plan view.

In the above-described structure, the dummy line 13C connected to the reference potential can restrain the electric field generated by the source line 18 from spreading into the liquid crystal layer 30 via the slit 12d when a source signal is applied to the source line 18. Thus, adverse effects of changes in the electrical potential of the source line 18 can be restrained, which can in turn further improve the display quality of the touch panel 1.

### Other Embodiments

The touch-panel-integrated display device in accordance with the present disclosure is not necessarily limited to the aforementioned embodiments and may be altered in various manners within the scope of the claims.

For instance, the shapes of the drive electrode 12A, the detection electrode 12B, and the common electrode 12C are not necessarily limited to the shapes described in the embodiments with reference to drawings and may be altered. Similarly, the shapes of the source line 18, the pixel electrode 11, the semiconductor layer 14, and other members are not necessarily limited to the shapes described in the embodiments and may be altered.

In addition, in the embodiments, the drive-electrode-connection wire 13A is divided in the region R2. Alternatively, in the region R2, the drive-electrode-connection wire 13A may be continuous, and the lead wire 13D may be divided and connected by a connection conductor that is electrically separated from the common electrode 12C. This description equally applies to the detection-electrode-connection wire 13B and the drive-electrode-connection wire 13A in the region R3.

The touch-panel-integrated display device in accordance with the present disclosure may be described as in the following. A touch-panel-integrated display device of a first configuration includes:

a plurality of pixel electrodes;

a common electrode layer disposed opposite the plurality of pixel electrodes;

a wiring layer stacked and disposed on the common electrode layer via an insulation layer; and

a touch panel driver, wherein

each of the common electrode layer and the wiring layer contains a plurality of nodes that are arranged two-dimensionally,

in each of the plurality of nodes, the common electrode layer contains:

at least one drive electrode;

at least one detection electrode forming an electrostatic capacitance between the at least one detection electrode and the at least one drive electrode; and

a common electrode located between the at least one drive electrode and the at least one detection electrode and an adjacent one of the plurality of nodes, and

in each of the plurality of nodes, the wiring layer contains:

a drive-electrode-connection wire overlapping the at least one drive electrode in a plan view and connecting the at least one drive electrode and the touch panel driver;

a detection-electrode-connection wire overlapping the at least one detection electrode in a plan view and connecting the at least one detection electrode and the touch panel driver; and

a dummy line overlapping the common electrode in a plan view.

According to the first configuration, since the common electrode is provided in each node, the drive electrode and the detection electrode can be relatively reduced in area. Therefore, the load on the drive electrode and the detection electrode can be reduced. In addition, the provision of the dummy lines for the common electrode can reduce the structural difference of the drive electrode and the detection electrode from the common electrode, and non-uniform displays caused by the structural difference can be restrained.

A touch-panel-integrated display device of a second configuration, in the first configuration, may be further configured so that the common electrode layer contains: a plurality of detection electrodes including the at least one detection electrode and the at least one drive electrode, and the at least one drive electrode is located between the plurality of detection electrodes.

A touch-panel-integrated display device of a third configuration, in the first configuration, may be further configured so that the plurality of detection electrodes are arranged in m rows and n columns where m and n are natural numbers, and the at least one drive electrode is shaped like a grid located between the plurality of detection electrodes.

A touch-panel-integrated display device of a fourth configuration, in the first configuration, may be further configured so that the common electrode, in each of the plurality of nodes, surrounds the plurality of detection electrodes and the at least one drive electrode.

A touch-panel-integrated display device of a fifth configuration, in the first configuration, may be further configured so that the common electrode is connected to a reference potential.

A touch-panel-integrated display device of a sixth configuration, in the first configuration, may be further configured so as to further include: a plurality of thin film transistors; a plurality of gate lines connected to gates of the plurality of thin film transistors and extending in a row direction; and a plurality of source lines connected to sources of the plurality of thin film transistors and extending in a column direction, wherein the detection-electrode-connection wire extends in the column direction and overlaps one of the plurality of source lines in a plan view, the drive-electrode-connection wire extends in the row direction and overlaps one of the plurality of gate lines in a plan view, and the dummy line extends in the column direction and overlaps another one of the plurality of source lines in a plan view.

A touch-panel-integrated display device of a seventh configuration, in the sixth configuration, may be further configured so that the detection-electrode-connection wire is disposed also in a location overlapping the common electrode in a plan view and is connected to the detection-electrode-connection wire that is located in an adjacent one of the plurality of nodes, and the drive-electrode-connection wire is disposed also in a location overlapping the common electrode in a plan view and is connected to the drive-electrode-connection wire that is located in an adjacent one of the plurality of nodes.

A touch-panel-integrated display device of an eighth configuration, in the seventh configuration, may be further configured so as to further include a lead wire disposed in a location overlapping the common electrode in a plan view and extending in the column direction, wherein the lead wire is connected to the drive-electrode-connection wire and overlaps one of the plurality of source lines in a plan view.

A touch-panel-integrated display device of a ninth configuration, in the eighth configuration, may be further configured so that the common electrode has a slit located between a pair of adjacent pixel electrodes in a plan view, and the dummy line overlaps the slit.

A touch-panel-integrated display device of a tenth configuration, in any one of the first to ninth configurations, may be further configured so that the dummy line and the common electrode are electrically insulated from each other, and the dummy line is floated.

A touch-panel-integrated display device of an eleventh configuration, in any one of the first to ninth configurations, may be further configured so that the dummy line is connected to the common electrode.

What is claimed is:

1. A touch-panel-integrated display device comprising:
a plurality of pixel electrodes;
a common electrode layer disposed opposite the plurality of pixel electrodes;
a wiring layer stacked and disposed on the common electrode layer via an insulation layer; and
a touch panel driver, wherein
each of the common electrode layer and the wiring layer contains a plurality of nodes that are arranged two-dimensionally,
in each of the plurality of nodes, the common electrode layer contains:
at least one drive electrode;
at least one detection electrode forming an electrostatic capacitance between the at least one detection electrode and the at least one drive electrode; and
a common electrode located between the at least one drive electrode and the at least one detection electrode and an adjacent one of the plurality of nodes, and
in each of the plurality of nodes, the wiring layer contains:
a drive-electrode-connection wire overlapping the at least one drive electrode in a plan view and connecting the at least one drive electrode and the touch panel driver;
a detection-electrode-connection wire overlapping the at least one detection electrode in a plan view and connecting the at least one detection electrode and the touch panel driver; and
a dummy line overlapping the common electrode in a plan view.

2. The touch-panel-integrated display device according to claim 1, wherein
the common electrode layer contains:
a plurality of detection electrodes including the at least one detection electrode, and
the at least one drive electrode, and
the at least one drive electrode is located between the plurality of detection electrodes.

3. The touch-panel-integrated display device according to claim 2, wherein
the plurality of detection electrodes is arranged in m rows and n columns where m and n are natural numbers, and
at least one drive electrode is shaped like a grid located between the plurality of detection electrodes.

4. The touch-panel-integrated display device according to claim 3, wherein the common electrode, in each of the plurality of nodes, surrounds the plurality of detection electrodes and the one drive electrode.

5. The touch-panel-integrated display device according to claim 1, wherein the common electrode is connected to a reference potential.

6. The touch-panel-integrated display device according to claim 1, further comprising:
a plurality of thin film transistors;
a plurality of gate lines connected to gates of the plurality of thin film transistors and extending in a row direction; and
a plurality of source lines connected to sources of the plurality of thin film transistors and extending in a column direction, wherein
the detection-electrode-connection wire extends in the column direction and overlaps one of the plurality of source lines in a plan view,
the drive-electrode-connection wire extends in the row direction and overlaps one of the plurality of gate lines in a plan view, and
the dummy line extends in the column direction and overlaps another one of the plurality of source lines in a plan view.

7. The touch-panel-integrated display device according to claim 6, wherein
the detection-electrode-connection wire is disposed also in a location overlapping the common electrode in a plan view and is connected to the detection-electrode-connection wire that is located in an adjacent one of the plurality of nodes, and
the drive-electrode-connection wire is disposed also in a location overlapping the common electrode in a plan view and is connected to the drive-electrode-connection wire that is located in an adjacent one of the plurality of nodes.

8. The touch-panel-integrated display device according to claim 7, further comprising a lead wire disposed in a location overlapping the common electrode in a plan view and extending in the column direction, wherein
the lead wire is connected to the drive-electrode-connection wire and overlaps one of the plurality of source lines in a plan view.

9. The touch-panel-integrated display device according to claim 8, wherein
the common electrode has a slit located between a pair of adjacent pixel electrodes in a plan view, and
the dummy line overlaps the slit.

10. The touch-panel-integrated display device according to claim 1, wherein
the dummy line and the common electrode are electrically insulated from each other, and
the dummy line is floated.

11. The touch-panel-integrated display device according to claim 1, wherein the dummy line is connected to the common electrode.
